(19) United States
(12) Patent Application Publication
(10) Pub. No.: US 2026/0366342 A1
(43) Pub. Date: Nov. 19, 2026

(54) SMART LOCK MECHANISM

(71) Applicant: HSIN CHONG MACHINERY WORKS CO. LTD., Taoyuan City (TW)

(72) Inventors: Guan-Yu CHEN, Taoyuan City (TW); Tzu-Cheng CHU, Taoyuan City (TW); Hai-Ying YANG, Taoyuan City (TW)

(21) Appl. No.: 19/211,948

(22) Filed: May 19, 2025

(51) Int. Cl. E05B 81/66; E05B 77/34; E05B 79/20; E05B 81/06; E05B 81/32

(52) U.S. Cl. CPC E05B 81/66; E05B 77/34; E05B 79/20; E05B 81/06; E05B 81/32

(57) ABSTRACT

This disclosure is directed to a smart lock mechanism having a ratchet an ice-breaking lever, a pawl a driving assembly, and a multifunctional lever, and a control board. The ice-breaking lever is engaged with the ratchet. A first magnetic element is arranged on the ice-breaking lever. A second magnetic element arranged on the pawl. The driving assembly has a motor, a bilateral pushing lever an unlocking lever group and a locking lever group, a third magnetic element arranged on the bilateral pushing lever. The control board is provided with a first ratchet sensor, a second ratchet sensor, a third ratchet sensor, a pawl sensor and an actuation sensor, and the control board is capable of detecting the ratchet at an unlock position, a semi-locked position or a locked position, detecting the pawl located a holding position, and detecting the bilateral pushing lever at the central position.

### BACKGROUND OF THE DISCLOSURE

### Technical Field

This disclosure is related to a door lock of car, in particular to a smart lock mechanism with multifunctional operation driven by single motor.

### Description of Related Art

A door lock of related art is installed on a door frame of a car for locking a door panel which is pivoted on the door frame. The door lock of car has a ratchet and a pawl which are rotatable. When a striker on the door panel is put into a ratcheting slot on the ratchet, the ratchet is rotated to deflect the ratcheting slot so that the striker cannot be retracted along an entering direction. The door lock may be locked by engaging the pawl with the ratchet and may be unlocked by retracting the pawl from the ratchet to allow the ratchet to rotate, and the striker is allowed to retract from the ratcheting slot.

A door lock of related art is operated only for unlocking, so only one actuator is arranged corresponding to the pawl, and a cable is used for operating the actuator to actuate the pawl. In order to meet the requirements of automatic locking, electric unlocking and other functions, a car door lock of related art should be provided with multiple motors and control circuits for performing various functions. Moreover, in general, multiple motors should be arranged corresponding to the motions for performing various functions. Therefore, a multifunctional electric vehicle door lock of related art is bulky and expensive to manufacture.

In views of this, in order to solve the above disadvantage, the inventor studied related technology and provided a reasonable and effective solution in this disclosure.

### SUMMARY OF THE INVENTION

This disclosure is related to a smart lock mechanism with multifunctional operation driven by single motor single motor.

This disclosure is directed to a smart lock mechanism having a structural assembly, a ratchet an ice-breaking lever, a pawl a driving assembly, a multifunctional lever and a control board. The structural assembly has a first shaft, a second shaft and a third shaft arranged thereon. The ratchet is pivoted on the first shaft and preset at an unlock position by a first reset element, and the ratchet is allowed to rotate to a locked position and a semi-locked position between the unlock position and the locked position. The ice-breaking lever is pivoted on the second shaft and engaged with the ratchet so as to be rotationally linked with the ratchet. A first magnetic element is arranged on the ice-breaking lever. The pawl is pivoted on the second shaft and preset at a holding position by a second reset element to hold the ratchet at the semi-locked position or the locked position, the pawl is capable of rotating to release the ratchet, and a second magnetic element is arranged on the pawl. The driving assembly has a motor, a bilateral pushing lever and an unlocking lever group and a locking lever group, the bilateral pushing lever is pivoted on the third shaft, the motor is used for rotating the bilateral pushing lever from a central position toward a locking direction or an unlocking direction, a third magnetic element is arranged on the bilateral pushing lever. The locking lever group is actuated by the bilateral pushing lever when the bilateral pushing lever rotated along the locking direction. The multifunctional lever is pivoted on the second shaft connected with the unlocking lever group, the multifunctional lever has a pawl actuating portion and an ice-breaking actuating portion, the pawl actuating portion being is used for pushing the pawl to unlock the ratchet. The multifunctional lever is actuated by the bilateral pushing lever the through the locking lever group when the bilateral pushing lever is rotated along the locking direction. The control board is provided with a first ratchet sensor, a second ratchet sensor, a third ratchet sensor, a pawl sensor and a actuation sensor, the control board is capable of detecting the ratchet at the unlock position, the semi-locked position or the locked position by detecting the first magnetic element on the ice-breaking lever with the third ratchet sensor, the second ratchet sensor or the first ratchet sensor correspondingly, the control board is capable of detecting the second magnetic element with the pawl sensor when the pawl is located at the holding position, the control board is capable of detecting the third magnetic element with the actuation sensor when the bilateral pushing lever is located at the central position.

In one embodiment of this disclosure, the locking lever group has a locking actuator, the locking actuator is pivoted on the third shaft and pivoted with a claw for engaging with the ratchet, the structural assembly is provided with a rail, the claw has a portion inserted in the rail. When the first magnetic element is detected by the first ratchet sensor and the second ratchet sensor in sequence, the control board drives the motor to rotate the bilateral pushing lever toward the locking direction to actuator the locking actuator to perform an electric locking process by moving the claw along the rail to rotate the ratchet until the first magnetic element is detected by both of the second ratchet sensor and the third ratchet sensor.

In one embodiment of this disclosure, when the first magnetic element is detected by the first ratchet sensor and the control board receives an unlocking order, the control board drive the motor to rotate the bilateral pushing lever toward the unlocking direction and actuate the unlocking lever group to perform an electric unlocking process by rotating the multifunctional lever to push the rachet away from the ratchet by the rachet actuating portion.

In one embodiment of this disclosure, if the first magnetic element is not detected by the first ratchet sensor when the control board drives the motor to rotate the bilateral pushing lever toward the unlocking direction, the control board drives the motor to further rotate the bilateral pushing lever toward the unlocking direction to perform an ice-breaking unlocking process by further rotating the multifunctional lever to actuate the ratchet until the first magnetic element is detected by the first ratchet sensor.

In one embodiment of this disclosure, if the first magnetic element is detected by the third ratchet sensor but the first magnetic element is not detected by the second ratchet sensor when the control board is performing an electric locking process, the control board drives the motor to reverse until the third magnetic element is detected by the actuation sensor.

In one embodiment of this disclosure, if the second magnetic element is not detected by the pawl sensor when the control board is performing an electric unlock process, the control board stop driving the motor to hold the pawl.

In one embodiment of this disclosure, if the first magnetic element is detected by the first ratchet sensor when the control board is performing the electric unlock process, the control board drives the motor to reverse until the third magnetic element is detected by the actuation sensor.

In one embodiment of this disclosure, if the first magnetic element is detected by the first ratchet sense when the control board is performing a process, the control board drives the motor to reverse until the third magnetic element is detected by the actuation sensor.

In one embodiment of this disclosure, the smart lock mechanism further has a rail arm, the rail arm is pivoted on the structural assembly, and the rail is arranged on the rail arm, the multifunctional lever pushes the rail arm away from the ratchet.

In one embodiment of this disclosure, the ratchet escapes from a moving route of the claw when the multifunctional lever is rotated to push the rail arm away from the ratchet.

In one embodiment of this disclosure, when the locking actuator is pushed by the bilateral pushing lever to rotate the ratchet toward the locked position, the multifunctional lever is meanwhile rotated to move the claw away from the ratchet.

In one embodiment of this disclosure, the pawl actuating portion and the ice-breaking actuating portion are branch arms extended from the multifunctional lever.

In one embodiment of this disclosure, the multifunctional lever pushes the ice-breaking lever to actuate the ratchet.

In one embodiment of this disclosure, the multifunctional lever is connected with a cable allowing the multifunctional lever to be pulled by the cable to rotate and push the pawl away from the ratchet.

The smart lock mechanism disclosed according to this disclosure performs an operation to the ratchet and the lock plate pawl by a bidirectional rotation of single motor, and the pawl is further provided with a multifunctional lever, so that various unlocking and locking actions may be respectively performed by single motor.

### BRIEF DESCRIPTION OF THE DRAWINGS

FIG. 1 is a perspective view showing a smart lock mechanism according to one embodiment of this disclosure.

FIG. 2 is an exploded view of the smart lock mechanism according to one embodiment of this disclosure.

FIG. 3 is a perspective view showing an inner structure of the smart lock mechanism according to one embodiment of this disclosure.

FIG. 4 is an exploded view of the inner structure of the smart lock mechanism according to one embodiment of this disclosure.

FIG. 5 is a perspective view showing another inner structure of the smart lock mechanism according to one embodiment of this disclosure.

FIG. 6 is a schematic view showing a manually unlocking process of the smart lock mechanism according to one embodiment of this disclosure.

FIG. 7 is a schematic view showing a semi-locked status of the smart lock mechanism according to one embodiment of this disclosure.

FIGS. 8 - 10 are schematic views showing a cinching process of the smart lock mechanism according to one embodiment of this disclosure.

FIG. 11 is a control signal diagram of an electric locking process of the smart door lock mechanism according to an embodiment of this disclosure.

FIG. 12 is a flow chart showing steps of the electric locking process of the smart door lock mechanism according to an embodiment of this disclosure.

FIGS. 13 - 15 are schematic views showing an electric unlocking process of the smart lock mechanism according to one embodiment of this disclosure.

FIG. 16 is a control signal diagram of an electric unlocking process of the smart door lock mechanism according to an embodiment of this disclosure.

FIG. 17 is a flow chart showing steps of the electric unlocking process of the smart door lock mechanism according to an embodiment of this disclosure.

FIG. 18 is a schematic view showing an ice-breaking process of the smart lock mechanism according to one embodiment of this disclosure.

FIG. 19 is a control signal diagram of an electric ice-breaking process of the smart door lock mechanism according to an embodiment of this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

It should be understood that the orientations or positional relationships in this disclosure which are indicated by the terms such as “front side”, “rear side”, “left side”, “right side”, “front end”, “rear end”, “end”, “vertical”, “horizontal”, “top” and “bottom” are based on the orientations or positional relationships as shown in the drawings. These are only used for describing this disclosure and simplifying the description rather than indicating or implying that the device or element have a specific orientation or be constructed and operated in a specific orientation, and it should not be considered as limitations of the scopes of this disclosure.

The terms used herein without additional definition such as “substantially” and “approximately” are used to describe and illustrate small changes. When used in an event or situation, the term may include the precise moment at which the event or situation occurs, and a close approximation to moment the event or situation occurs. For example, when combined with a numerical value, the term may include a range of variation less than or equal to ±10% of the numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Detailed descriptions and technical contents of this disclosure is described in the flowing paragraph with reference to the drawings. However, the drawings are attached only for illustration and are not intended to limit this disclosure.

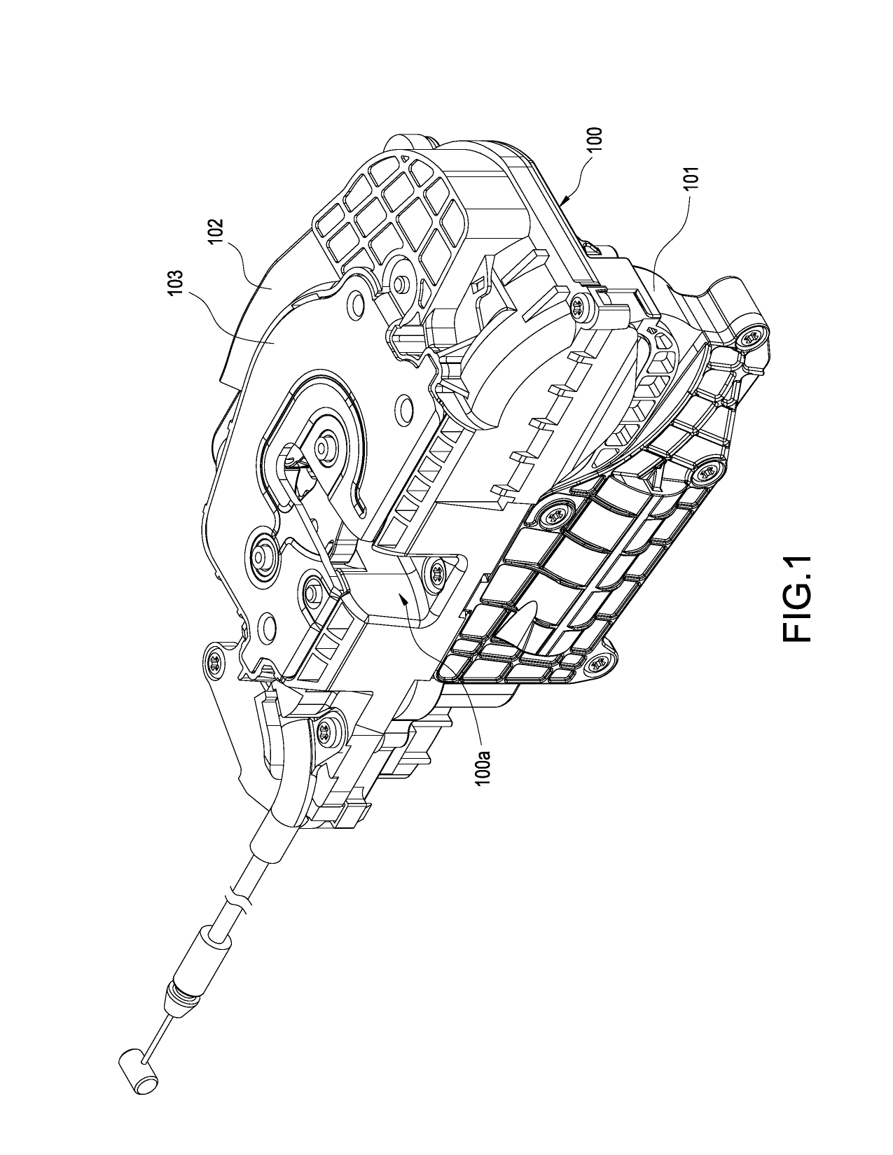

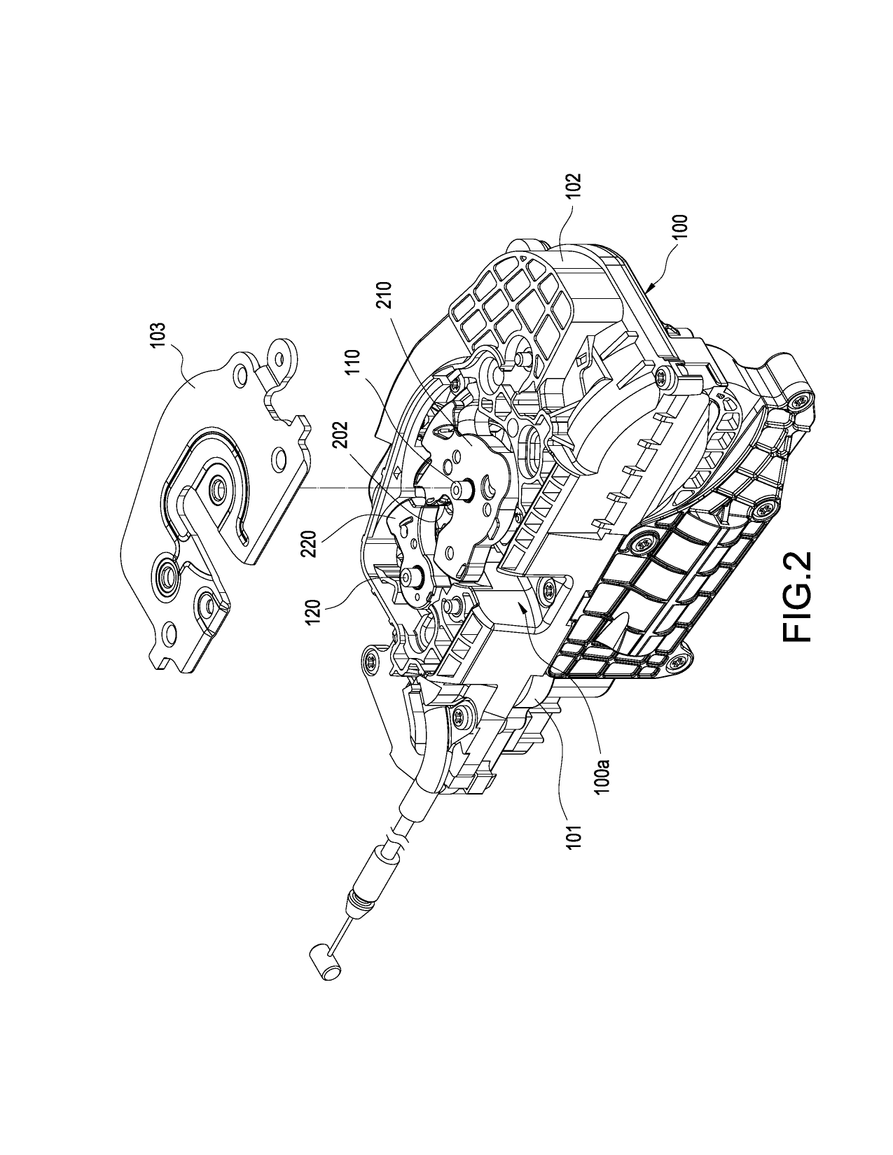

FIG. 1 is a perspective view showing a smart lock mechanism according to one embodiment of this disclosure. FIG. 2 is an exploded view of the smart lock mechanism according to one embodiment of this disclosure. According to FIGS. 1 and 2, this disclosure provides a smart lock mechanism which is applied on a door frame of a car for locking a door panel pivoted on the frame. The smart lock mechanism has a structural assembly 100, a ratchet 210, a pawl 220, a driving assembly 300 and a multifunctional lever 410. The structural assembly 100 of this disclosure should not be limited to specific types, the structural assembly 100 may have multiple housing parts (101, 102, 103), the ratchet 210 and the pawl 220 are arranged on the structural assembly 100. The structural assembly 100 has an entrance pass 100a allowing a striker on the door panel to lock into the smart lock mechanism.

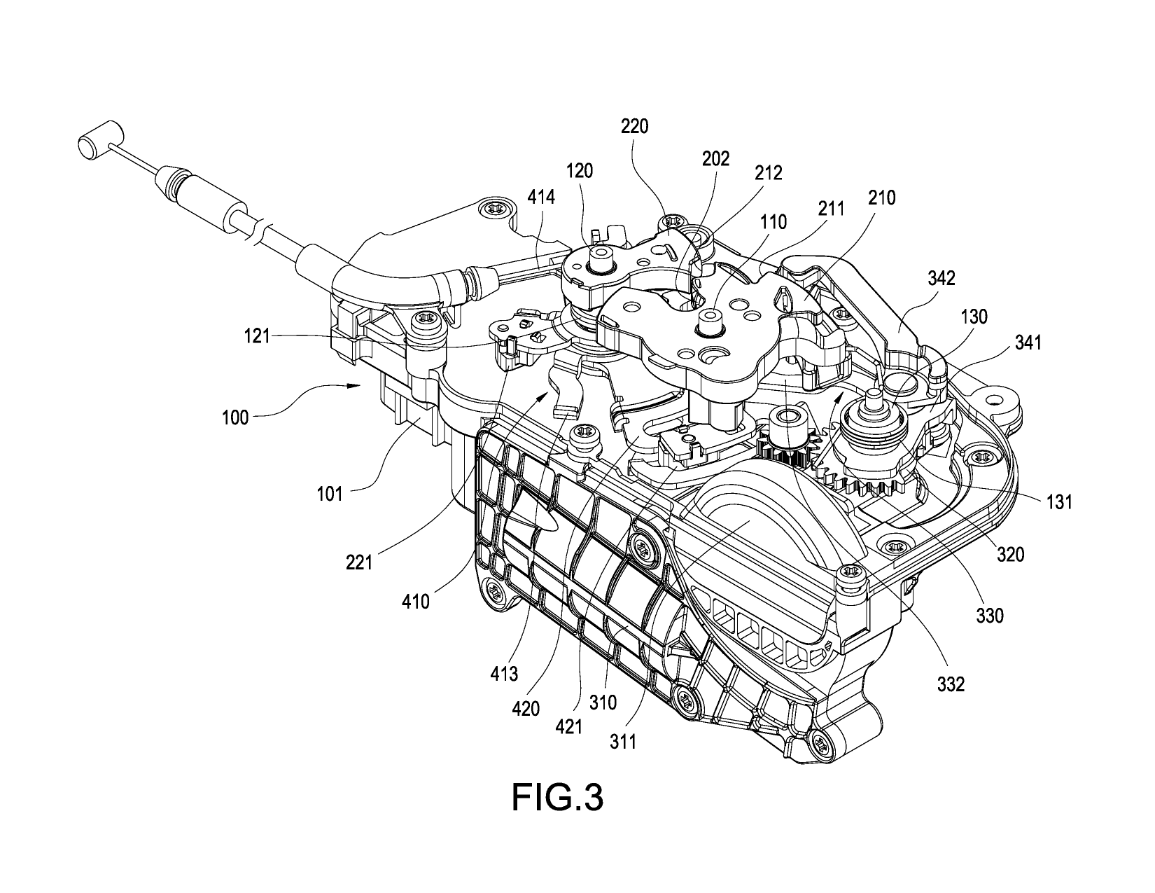

FIG. 3 is a perspective view showing an inner structure of the smart lock mechanism according to one embodiment of this disclosure. According to FIGS. 2 and 3, the structural assembly 100 is provided with a first shaft 110, a second shaft 120 and a third shaft 130. The first shaft 110, the second shaft 120 and the third shaft 130 are arranged on one surface on one housing part 101, the ratchet 210 is pivoted on the first shaft 110, the pawl 220 is pivoted on the second shaft 120, and the housing parts (101, 102, 103) are assembled with each other to contain the first shaft 110, the second shaft 120 and the third shaft 130 in the structural assembly 100.

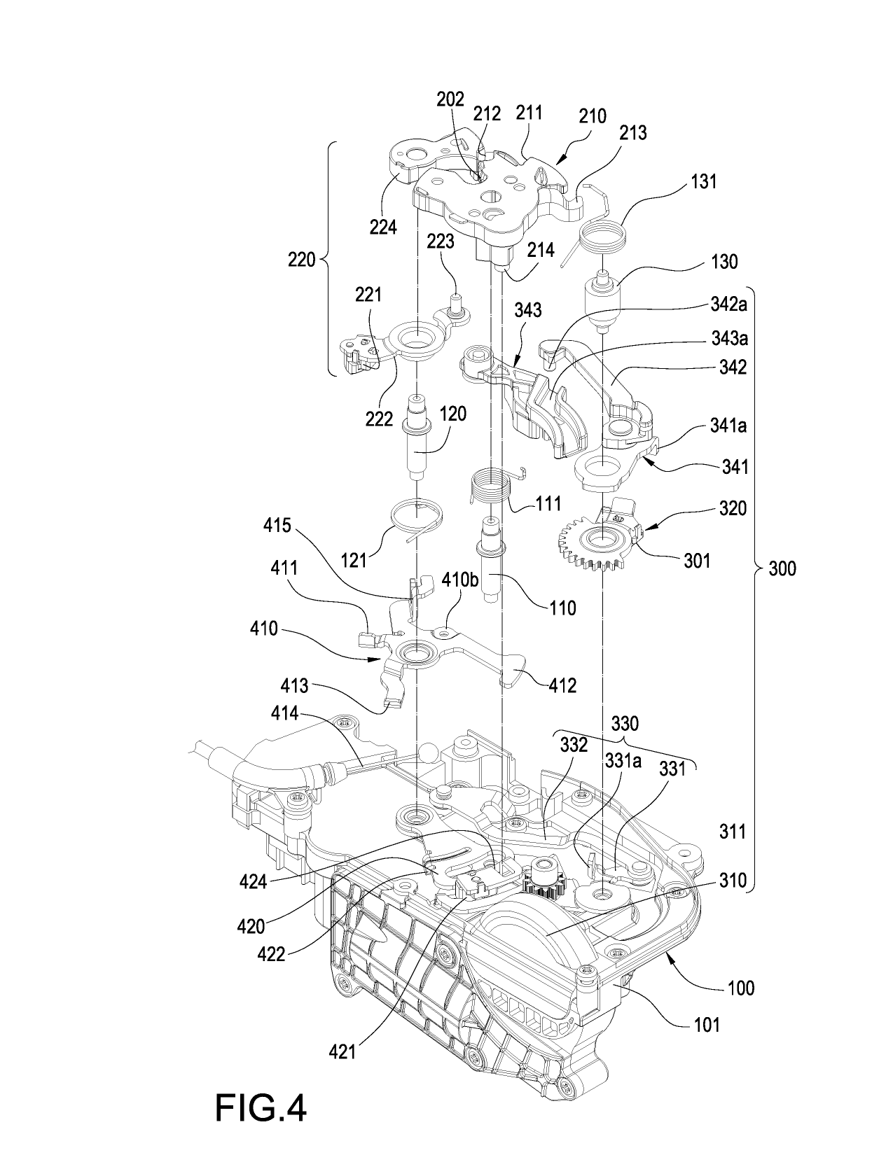

FIG. 4 is an exploded view of the inner structure of the smart lock mechanism according to one embodiment of this disclosure. According to FIGS. 3 and 4, the ratchet 210 is pivoted on the first shaft 110 and defined with a preset status by a first reset element 111. According to this embodiment the first reset element 111 is a cylindrical spring sheathing the first shaft 110, and the ratchet 210 is pressed by the first reset element 111. The pawl 220 is pivoted on the second shaft 120 and defined with a preset status by a second reset element 121. According to this embodiment, the second reset element 121 is a cylindrical spring sheathing the second shaft 120, and the pawl 220 is pressed by the second reset element 121.

According to the smart lock mechanism of this disclosure, the driving assembly 300 further has a locking lever group 340, and the locking lever group 340 has a locking actuator 341, a claw 342 and a rail arm 343. The ratchet 210 has a passive hook 213. The locking actuator 341 is pivoted on the third shaft 130, and a claw 342 is pivoted on the locking actuator 341 for holding the ratchet 210. Specifically, the passive hook 213 is extended from an edge of the ratchet 210 for engaging the claw 342. The locking actuator 341 is defined with a preset status by a third reset element 131. According to this embodiment, the third reset element 131 is a spiral spring sheathing the third shaft 130, the locking actuator 341 is pressed by the third reset element 131.

The rail arm 343 is pivoted on the structural assembly 100, and the rail arm 343 is provided with a rail 343a. The claw 342 has a portion inserted in the rail 343a so that the claw 342 may be guided by the rail 343a when moving. Specifically, the claw 342 has a guide pin 342a, and the guide pin 342a is inserted in the rail 343a to be slidable along the rail 343a.

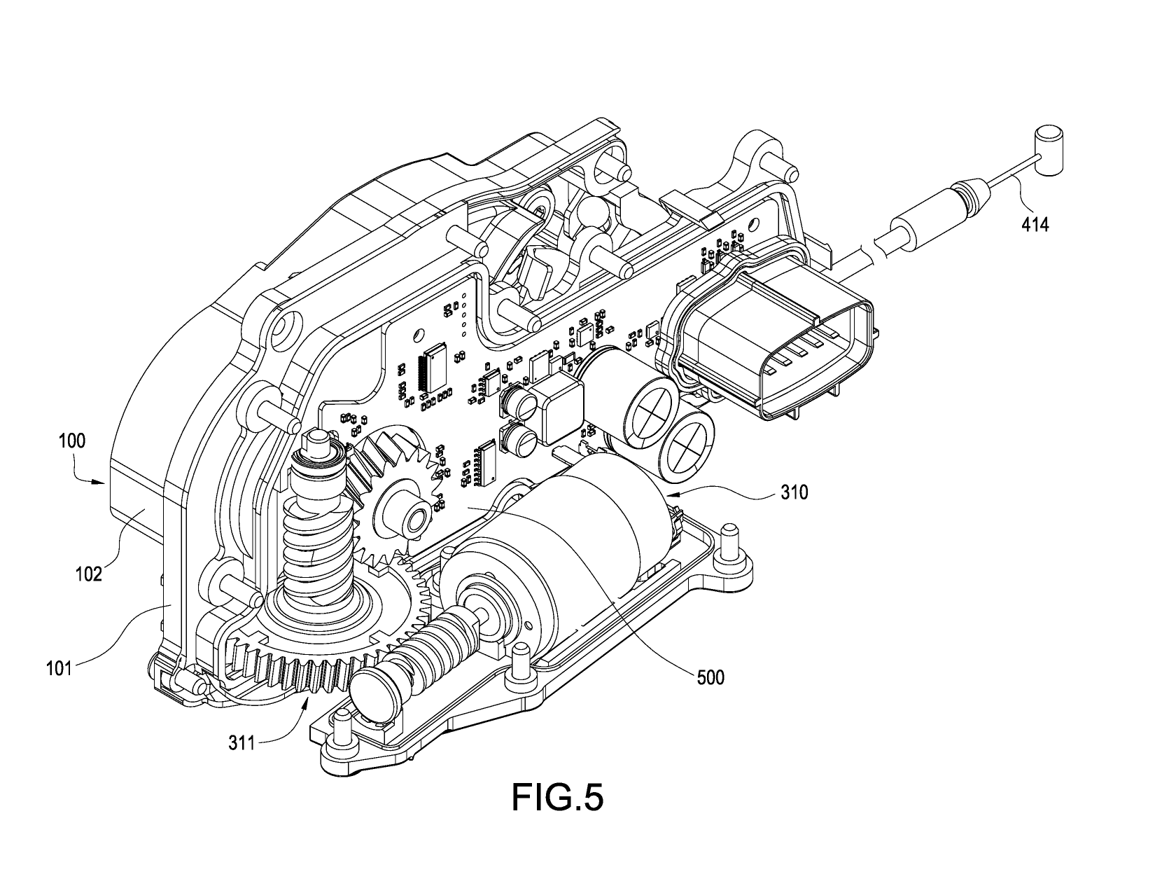

FIG. 5 is a perspective view showing another inner structure of the smart lock mechanism according to one embodiment of this disclosure. According to FIGS. 3 - 5, the driving assembly 300 has a motor 310, a bilateral pushing lever 320 and an unlocking lever group 330, the motor 310 may be arranged on another side of the housing part 101 mentioned above, the bilateral pushing lever 320 is pivoted on the third shaft 130, the bilateral pushing lever 320 may be actuated by the motor 310 to rotate bilaterally. The bilateral pushing lever 320 may be kinetically connected with the motor 310 via at least one transmission gear 311, the motor 310 and the transmission gear 311 may be respectively arranged on two sides of the housing part 101 mentioned above. The unlocking lever group 330 has two levers (331, 332).

The multifunctional lever 410 is connected to the unlocking lever group 330 and rotationally linked with the unlocking lever group 330. Specifically, the multifunctional lever 410 and the levers (331, 332) are pivotally connected with each other. The multifunctional lever 410 may be a bent metal piece, and one of the levers 331 has one end pivoted to the third shaft 130 and another end pivoted to one end of the other of the levers 332. The other lever 332 has another end pivoted to an actuating portion 410b on a periphery of the multifunctional lever 410, the multifunctional lever 410 is pivoted on the second shaft 120.

The smart lock mechanism according to this disclosure further has a control board 500. The control board 500 and the motor 310 are arranged together on one side of the housing part 101 mentioned above, and the motor 310 is electrically connected to the control board 500 so that the motor 310 may be controlled via the control board 500. The lever 331 pivoted on the third shaft 130 has a portion on a periphery thereof which is bent to form an interference wall 331a, the locking actuator 341 has a portion on a periphery thereof which is bent to form another interference wall 341a, the bilateral pushing lever 320 is disposed between two of the interference walls (331a, 341a) and may be rotated toward one of said two interference walls so as to selectively push the locking actuator 341 or the unlocking lever group 330. The smart lock mechanism of this disclosure further has a control board 500. The control board 500 is disposed together with the motor 310 on the same side on the housing part 101, and the motor 310 is electrically connected to the control board 500, so that the control board 500 may control the motor 310. The lever 331 pivoted on the third shaft 130 has an interference wall 331a on a periphery thereof which is a bent portion, the locking actuator 341 has an interference wall 341a on a periphery thereof which is a bent portion, the bilateral pushing lever 320 is disposed between two of the interference walls (331a, 341a) and preset at an central position, so that the bilateral pushing lever 320 may be rotated from the central position to one of the interference walls (331a, 341a) to selectively actuate the locking actuator 341 or the unlocking lever group 330.

According to FIGS. 3 and 4, the smart lock mechanism of this disclosure further has an ice-breaking lever 420, the ice-breaking lever 420 is a bent metal piece, the ice-breaking lever 420 is pivoted on the second shaft 120 and engaged with the ratchet 210 so as to be rotationally linked with each other. Specifically, the ice-breaking lever 420 has one end pivoted to the second shaft 120 and another end provided with an engaging slot 424. The ratchet 210 has a linked hook 214 so as to engage the engaging slot 424 of the ice-breaking lever 420. The engaging slot 424 is extended along a radial direction of the second shaft 120. The ice-breaking lever 420 is provided with a first magnetic element 421, and the pawl 220 is provided with a second magnetic element 221. The control board 500 may detect motions of the first magnetic element 421 and the second magnetic element 221. Specifically, the pawl 220 has a actuating lever 222 and a pawl body 224, the actuating lever 222 and the pawl body 224 are pivoted on the second shaft 120, the pawl body 224 is used for engaging the ratchet 210, the actuating lever 222 has a plug pin 223 disposed on one end thereof, the plug pin 223 is inserted into the pawl body 224. The pawl body 224 has one end pivoted to the second shaft 120 and another end used for engaging the ratchet 210. Since the pawl body 224 cannot be pushed away from the ratchet 210 by pushing a portion between the pawl body 224 and the ratchet 210, the actuating lever 222 is extended to another side of the second shaft 120 to pushing the pawl body 224, thereby rotating the pawl body 224. The actuating lever 222 has another end allowing a second magnetic element 221 to be arranged thereon, and the end is bent at a tip thereof to enhance structural strength and allow the multifunctional lever 410 to press thereon. The first magnetic element 421 is arranged on the ice-breaking lever 420 and rotationally linked with the ratchet 210 to be moveable along an arc path about the second shaft 120 as a center, so that the first magnetic element 421 has a longer movable range and therefore may detect more accurately.

The multifunctional lever 410 has a pawl actuating portion 411, an ice-breaking actuating portion 413 and an unlocking portion 415. When the multifunctional lever 410 is rotated by the unlocking lever group 330, the actuating lever 222 of the pawl 220 is pushed by the pawl actuating portion 411 to rotate the pawl body 224 to unlock the ratchet 210, and the ice-breaking actuating portion 413 and the unlocking portion 415 are rotated at the same time.

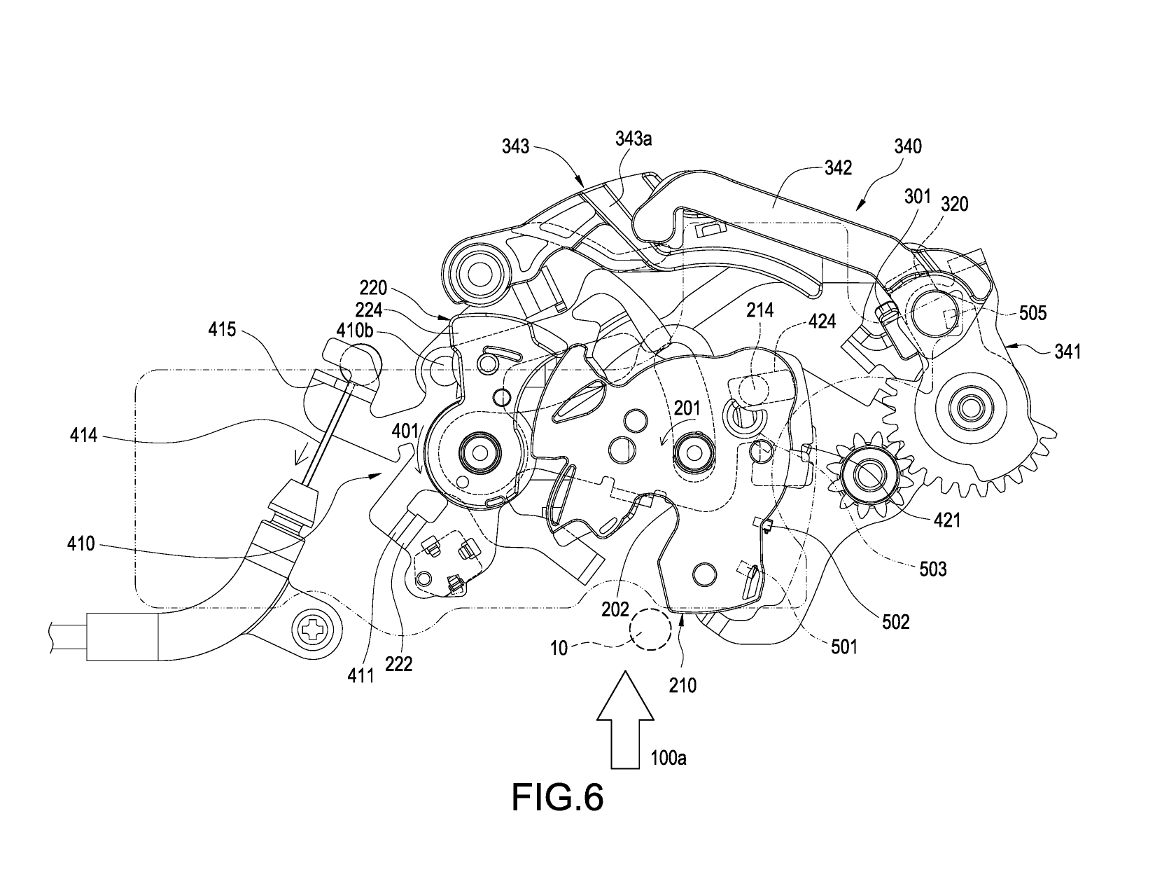

FIG. 6 is a schematic view showing a manually unlocking process of the smart lock mechanism according to one embodiment of this disclosure. According to FIG. 6, the multifunctional lever 410 has a pawl actuating portion 411 for pushing the actuating lever 222 of the pawl 220, the pawl actuating portion 411 is a branch arm extended from the multifunctional lever 410. The second reset element 121 applies a force on the actuating lever 222, and the pawl actuating portion 411 may have a bent end as a reinforced structure for pushing against the actuating lever 222. The multifunctional lever 410 is further provided with a cable 414 connected to the unlocking portion 415, the unlocking portion 415 is a branch arm extended from the multifunctional lever 410, the unlocking portion 415 may be pulled by the cable 414 to rotate the multifunctional lever 410 toward an actuating direction 401 to push the pawl 220 away from the ratchet 210. When the ratchet 210 is released from the pawl 220 and rotated toward a releasing direction 201 to reset to the preset status as an unlock position, namely that the ratchet 210 is defined with a releasing direction 201 which is a rotational direction toward the unlock position. The control board 500 is provided with a ratchet sensor 501 corresponding to the unlock position of the ratchet 210 so that the control board 500 may detect the first magnetic element 421 via the ratchet sensor 501 correspondingly when the ratchet 210 is located at the unlock position, and the control board 500 is provided with a pawl sensor 504 so that the control board 500 may detect the second magnetic element 221 via the pawl sensor 504 correspondingly when the pawl 220 is rotated to release the ratchet 210. The ratchet 210 has a ratcheting slot 202 on a periphery thereof, the ratcheting slot 202 is used for accommodating the striker 10 on the door panel, and the ratcheting slot 202 is aligned to the entrance pass 100a when the ratchet 210 is located at the unlock position so that the striker 10 is allowed to enter the ratcheting slot 202 through the entrance pass 100a. The multifunctional lever 410 has a rail actuating portion 412, the rail actuating portion 412 is a branch arm extended from the multifunctional lever 410. The rail arm 343 may be pushed away from the ratchet 210 by the rail actuating portion 412 when the multifunctional lever 410 is rotated toward the actuating direction 401 for unlocking, so that the ratchet 210 may escape from a moving route of the claw 342.

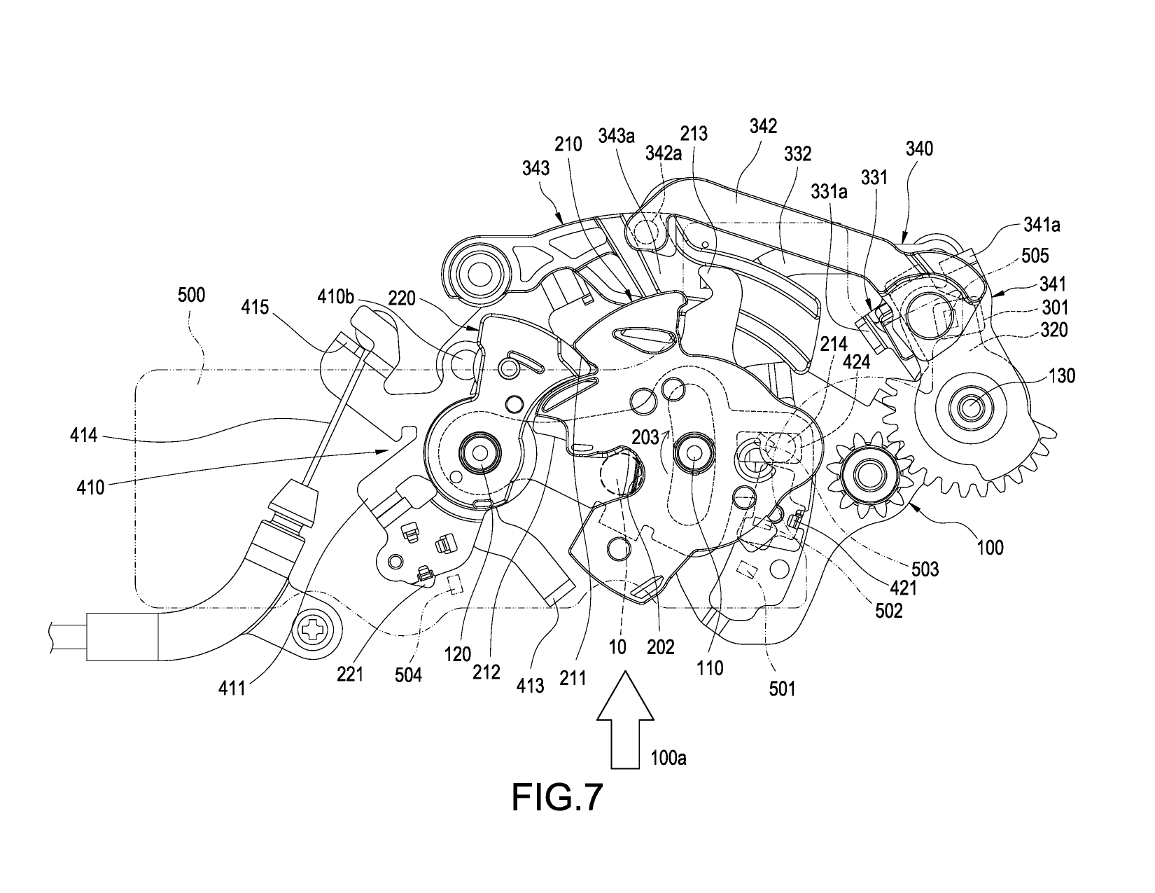

FIG. 7 is a schematic view showing a semi-locked status of the smart lock mechanism according to one embodiment of this disclosure. According to FIGS. 6 and 7, the first shaft 110 is disposed at a side of the entrance pass 100a. When the striker 10 is moved into the ratcheting slot 202 through the entrance pass 100a, the ratchet 210 is then pushed away from the unlock position by the striker 10, and the ratchet 210 is meanwhile rotated toward a direction which is opposite to the releasing direction 201 and defined as a ratcheting direction 203. According to FIG. 7, when the ratchet 210 is rotated away from the unlock position, the ratcheting slot 202 is rotated to cross the entrance pass 100a, and the striker 10 is therefore limited in an intercross of the ratcheting slot 202 and the entrance pass 100a. The ratchet 210 has a semi-lock holding portion 211 on the periphery thereof, when the ratchet 210 is located at the semi-locked position, the pawl 220 is in the preset status and at a holding position, a periphery of the pawl 220 holds the semi-lock holding portion 211 of the ratchet 210 to position the ratchet 210 at the semi-locked position. Specifically, the semi-lock holding portion 211 is a structure facing the releasing direction 201, thereby stopping the ratchet 210 from rotating toward the releasing direction 201. The control board 500 is provided with ratchet sensors corresponding to the unlock position and the semi-locked position of the ratchet 210, and ratchet sensors include a second ratchet sensor 502 corresponding to the semi-locked portion, so that the control board 500 may detect the first magnetic element 421 with the second ratchet sensor 502 when the ratchet 210 is positioned at the semi-locked position,

When the striker 10 is moved into the ratcheting slot 202, the ratchet 210 may be rotated to the semi-locked position and held by the pawl 220. The control board 500 may detect a motion of the first magnetic element 421 via the first ratchet sensor 501 and the second ratchet sensor 502 corresponding to the semi-locked position and the unlock position and correspondingly process a cinching process described following.

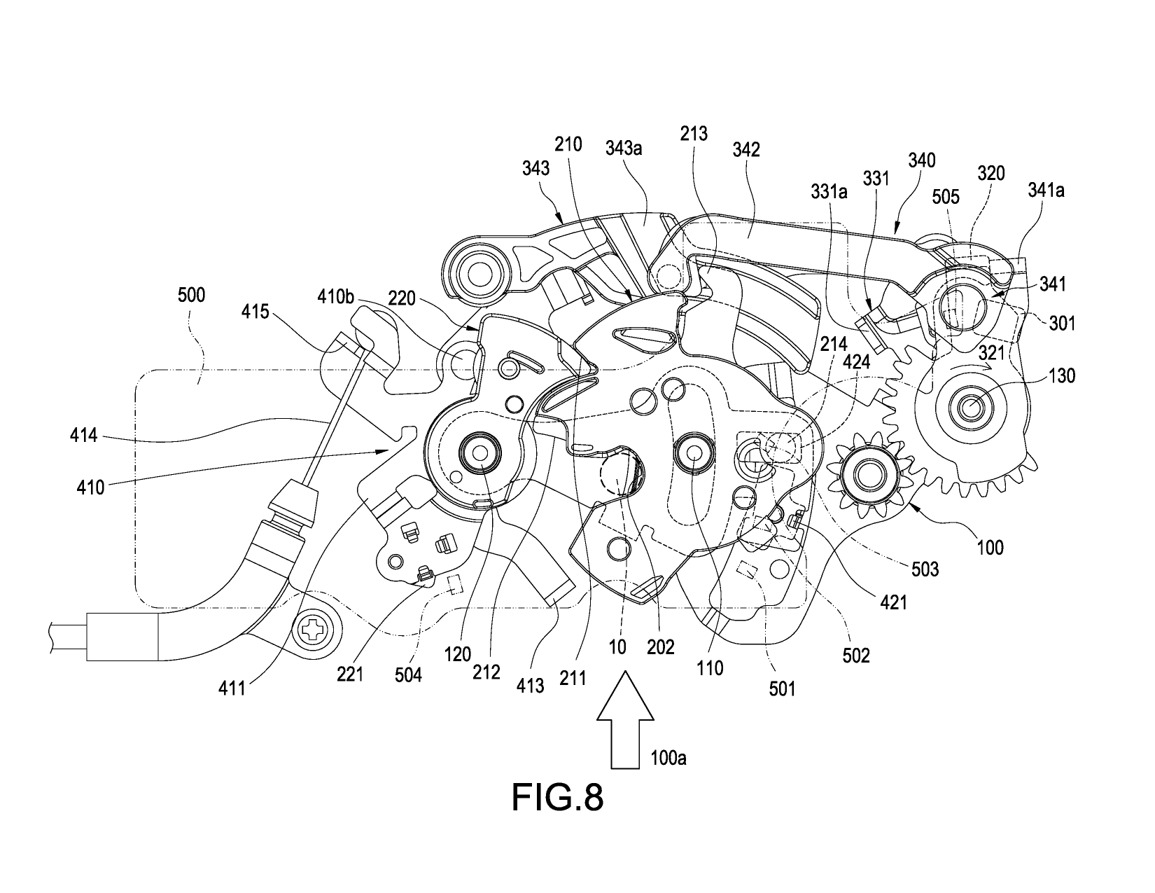

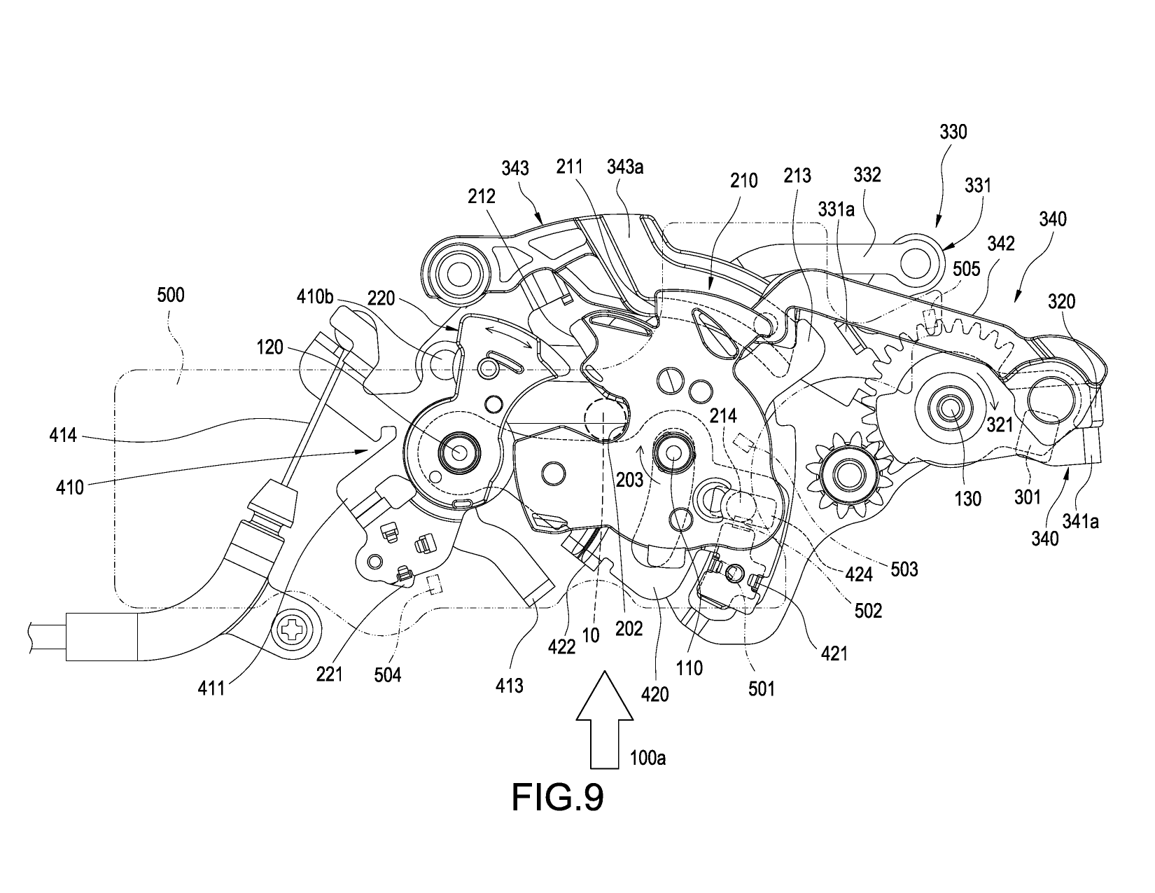

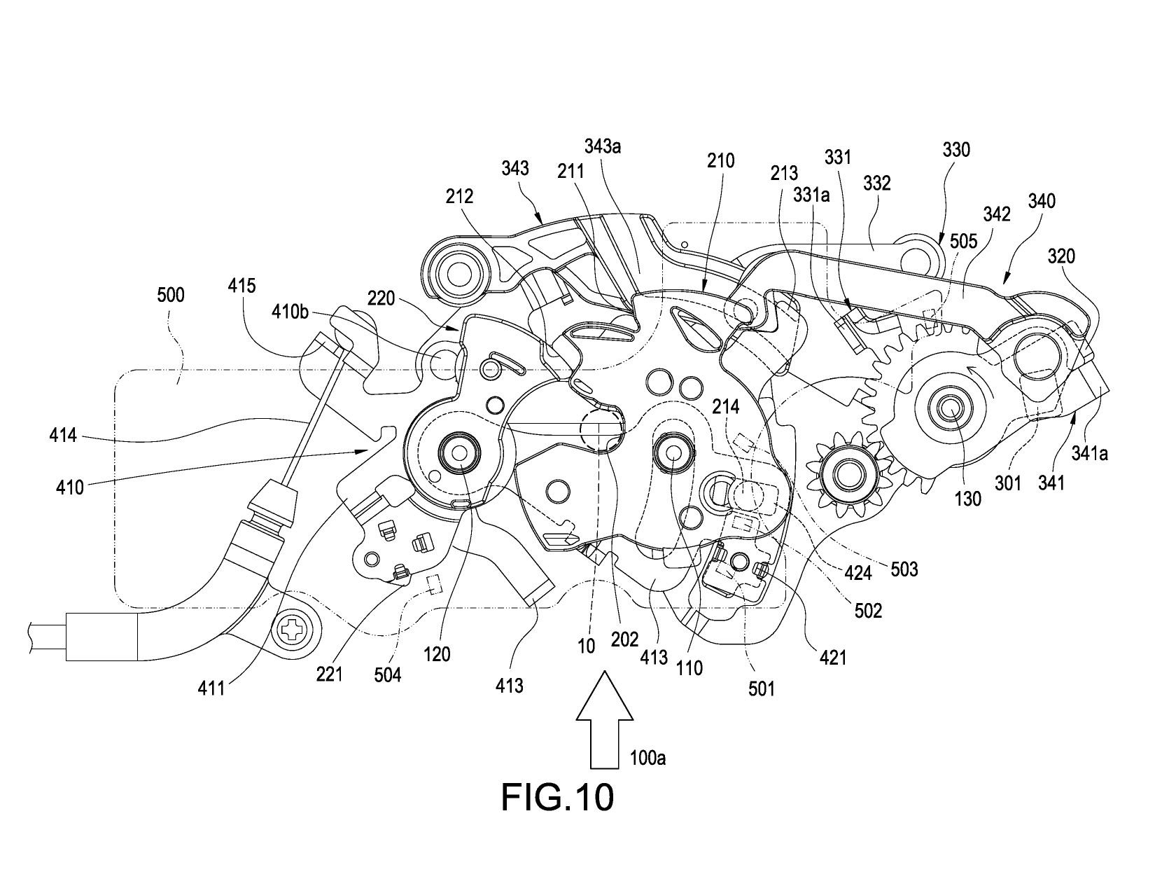

FIGS. 8 - 10 are schematic views showing a cinching process of the smart lock mechanism according to one embodiment of this disclosure. According to FIG. 8, the control board 500 may actuate the bilateral pushing lever 320 via the motor 310 to rotate toward a locking direction 321 and link the locking lever group 340, so that the passive hook 213 is linked by the claw 342 to actuate the ratchet 210 to lock. Specifically, the bilateral pushing lever 320 pushes the locking actuator 341, so that the claw 342 is moved along the rail 343a to the passive hook 213 of the ratchet 210. According to FIG. 9, when the passive hook 213 is engaged with the claw 342, the bilateral pushing lever 320 is then rotated toward the locking direction 321 to push the locking actuator 341, the claw 342 is moved with the locking actuator 341 along the rail 343a to rotate the ratchet 210 from the semi-locked position toward the ratcheting direction 203. The ratchet 210 has a lock holding portion 212 on the periphery thereof. When the ratchet 210 moves away from the semi-locked position, the pawl 220 leaves from the semi-lock holding portion 211 and presses on the periphery of the ratchet 210, so that the pawl 220 relatively slides on the periphery of the ratchet 210, and the lock holding portion 212 moves toward the pawl 220 along the ratcheting direction 203. Specifically, the lock holding portion 212 is a structure facing the releasing direction 201, so as to stop the ratchet 210 from rotating toward the releasing direction 201. The lock holding portion 212 arrives at the pawl 220 when the ratchet 210 is rotated to the locked position, and the pawl 220 is meanwhile reset to the holding position. According to FIG. 10, the pawl 220 snaps on the lock holding portion 212 to hold the ratchet 210 at the locked position. Accordingly, the cinching process allows the user may only move the striker 10 into the ratcheting slot 202, and then the control board 500 may process the cinching process. The control board 500 is provided with a ratchet sensor 503 corresponding to the locked position of the ratchet 210, the control board 500 may detect the first magnetic element 421 via the ratchet sensor 503 correspondingly when the ratchet 210 is located at the locked position.

The control board 500 is provided with a third ratchet sensor 503 disposed thereon corresponding to the locked position of the ratchet 210, and the control board 500 may detect the first magnetic element 421 with the third ratchet sensor 503 correspondingly when the ratchet 210 is located at the locked position. The control board 500 is provided with an actuation sensor 505, and the control board 500 may detect the third magnetic element 301 with the actuation sensor 505 when the bilateral pushing lever 320 is located at the central position which is predetermined.

Specifically, the sensors (the ratchet sensors, the pawl sensor 504 and the actuation sensor 505) may generate a high voltage signal when detecting the magnetic elements (the first magnetic element 421, the magnetic element 221 and the third magnetic element 301) correspondingly, or a low voltage signal otherwise. The control board 500 may determine the positions and motions of the ratchet plate 210, the lock plate 220 and the bidirectional push rod 320 according to the states of the high voltage signals or the low voltage signals of the sensors, and the motor 310 is further driven accordingly to actuate the bidirectional push rod 320 to perform corresponding actions.

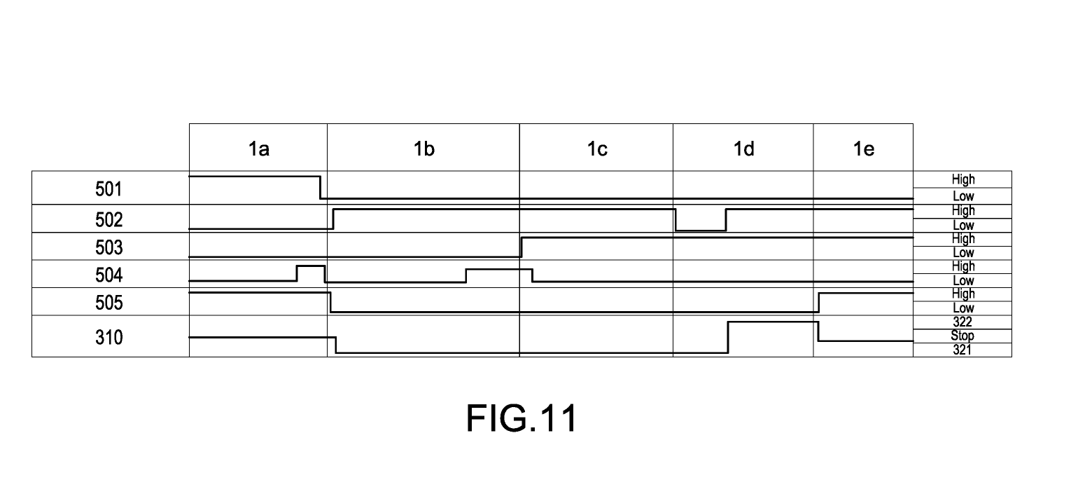

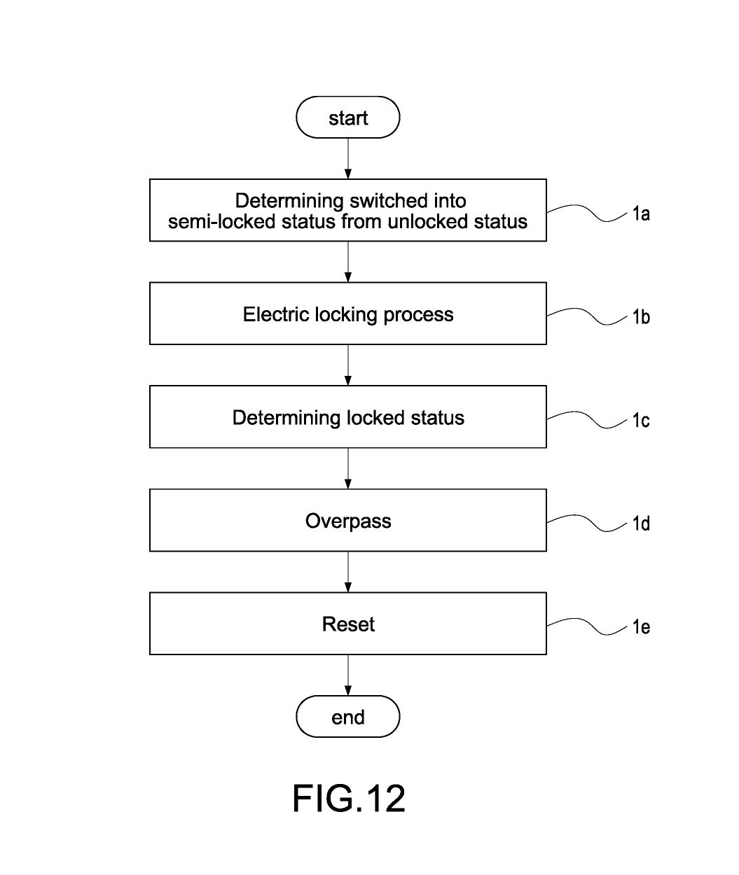

FIG. 11 is a control signal diagram of an electric locking process of the smart door lock mechanism according to an embodiment of this disclosure. FIG. 12 is a flow chart showing steps of the electric locking process of the smart door lock mechanism according to an embodiment of this disclosure.

The control board 500 performs the electric locking process with the following steps:

1a) Determining that the ratchet 210 is switched into a semi-locked status from an unlocked status: According to FIGS. 6-7, 11 and 12, the control board 500 may receive a high voltage signal corresponding to the unlock position when the first magnetic element 421 is detected by the first ratchet sensor 501 and receive another high voltage signal when the third magnetic element 301 is detected by the actuation sensor 505, namely that the ratchet 210 is determined at the unlock position and the bidirectional push rod 320 is determined at the central position, and the remained sensors are meanwhile detected with a low voltage signal. When the control board 500 receives a high potential signal from the pawl sensor 504 in a short time and meanwhile detects that the first ratchet sensor 501 is switched to low voltage signal and the second ratchet sensor 502 corresponding to the semi-locked position is switched to high voltage signal. Accordingly, the control board 500 determines that the pawl 220 is pushed away by the ratchet 210 and then reset and the ratchet 210 is rotated from the unlock position to the semi-locked position, and then process the next step.

1b) Performing an electric locking process at the semi-locked status: According to FIGS. 8 - 9 and 11 - 12, then, the control board 500 detects that the second ratchet sensor 502 is switched to low voltage signal, and determines that the ratchet 210 is in a status which is held at the semi-locked position. The control board 500 drives the motor 310 to rotate forward to actuate the bidirectional push rod 320 to rotate toward the locking direction 321 (the actuation sensor 505 is switched to low voltage signal) and further push the locking actuator 341. The locking actuator 341 rotates the ratchet 210 toward the ratcheting direction 203. When the control board 500 receives a high voltage single from the pawl sensor 504 and meanwhile detect that the third ratchet sensor 503 is switched to high voltage signal. The control board 500 determines that the ratchet 210 is switched into a locked status and the pawl 220 is pushed away meanwhile, and then process the next step.

1c) Determining the locked status: When the control board 500 receives high voltage signals from both of the second ratchet sensor 502 and the third ratchet sensor 503, the control board 500 accordingly determines that the ratchet 210 is located at the locked position, and the next step will be performed if ratchet 210 passes the locked position.

1d) Overpass: According to FIGS. 9 - 12, the control board 500 detects that the second ratchet sensor 502 is switched to low voltage signal and the third ratchet sensor 503 keeps generate high voltage signal, the control board 500accordingly determines that the ratchet 210 has exceeded the locked position, and the control board 500 reverse the motor 310 (backward)to reset the bidirectional push rod 320 to the central position to release the ratchet 210. The ratchet 210 may be reset to the locked position by the first reset element 111. The ratchet 210 may be held and positioned by the lock holding portion 212 when reset to the locked position, meanwhile the control board 500 may detect that the second ratchet sensor 502 is switched to high voltage and determined as a locked status, so that the electric locking process is accomplished.

1e) Reset: The control board 500 stop the motor 310 when detecting the third magnetic element 301 with the actuation sensor 505, namely that the bidirectional push rod 320 is reset to the central position.

Referring again to FIG. 6, according to the description above, the multifunctional lever 410 further rotates toward the actuating direction 401 to push the rail arm 343 away from the ratchet 210 when rotating to unlock, so that the ratchet 210 may escape from the moving route of the claw 342. Accordingly, when an emergency situation occurs in the cinching process (for example, a foreign object or a hand is caught), the multifunctional lever 410 may be actuated by the cable 414 to rotate toward the actuating direction 401, thereby blocking the linkage between the claw 342 and the ratchet 210 and unlocking the ratchet 210 at the same time.

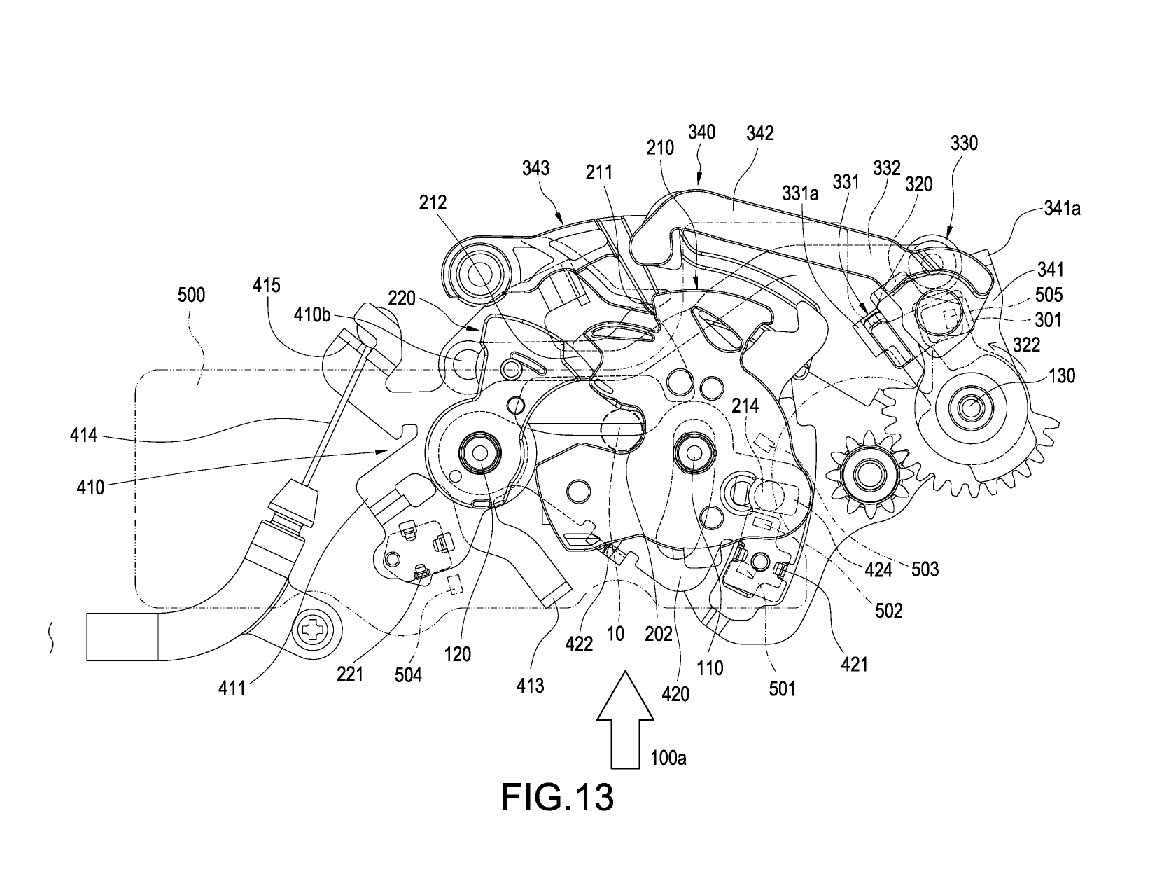

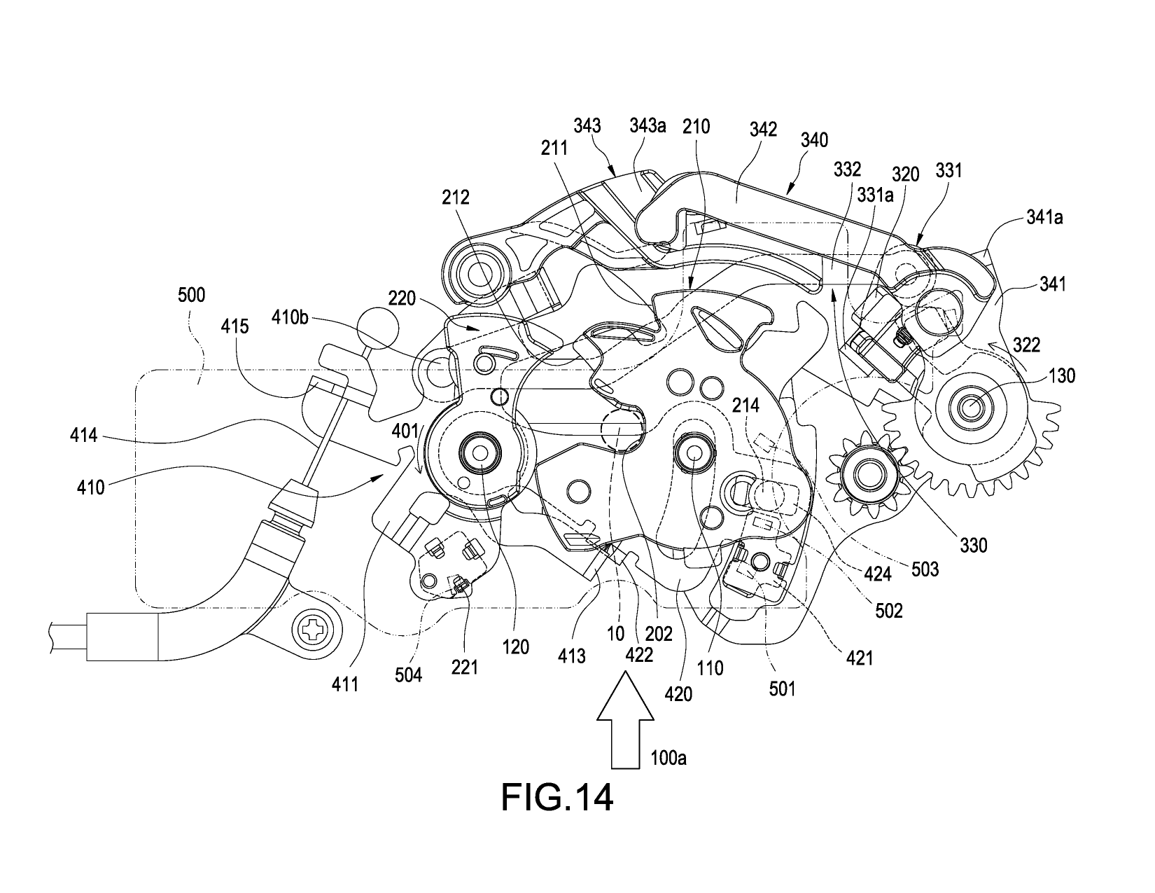

FIGS. 13 - 15 are schematic views showing an electric unlocking process of the smart lock mechanism according to one embodiment of this disclosure. According to FIG. 13 and 14, the bilateral pushing lever 320 may be rotated toward an unlocking direction 322 to push the unlocking lever group 330 and rotate the multifunctional lever 410 toward the actuating direction 401 so that the pawl 220 is pushed away from the ratchet 210. When the control board 500 processes an electric unlocking process described following when receiving an unlocking order. The bilateral pushing lever 320 is actuated by the control board 500 to rotate toward the unlocking direction 322 to correspondingly push the interference wall 331a on the lever 331 of the locking actuator 341. The lever 331 further actuates the lever 332 linked therewith to move the actuating portion 410b of the multifunctional lever 410, thereby rotating the multifunctional lever 410 toward the actuating direction 401 to push the pawl 220 away from the ratchet 210. According to FIG. 13, the ratchet 210 is released and then actuated by the first reset element 111 to rotate toward the releasing direction 201 to the unlocking position.

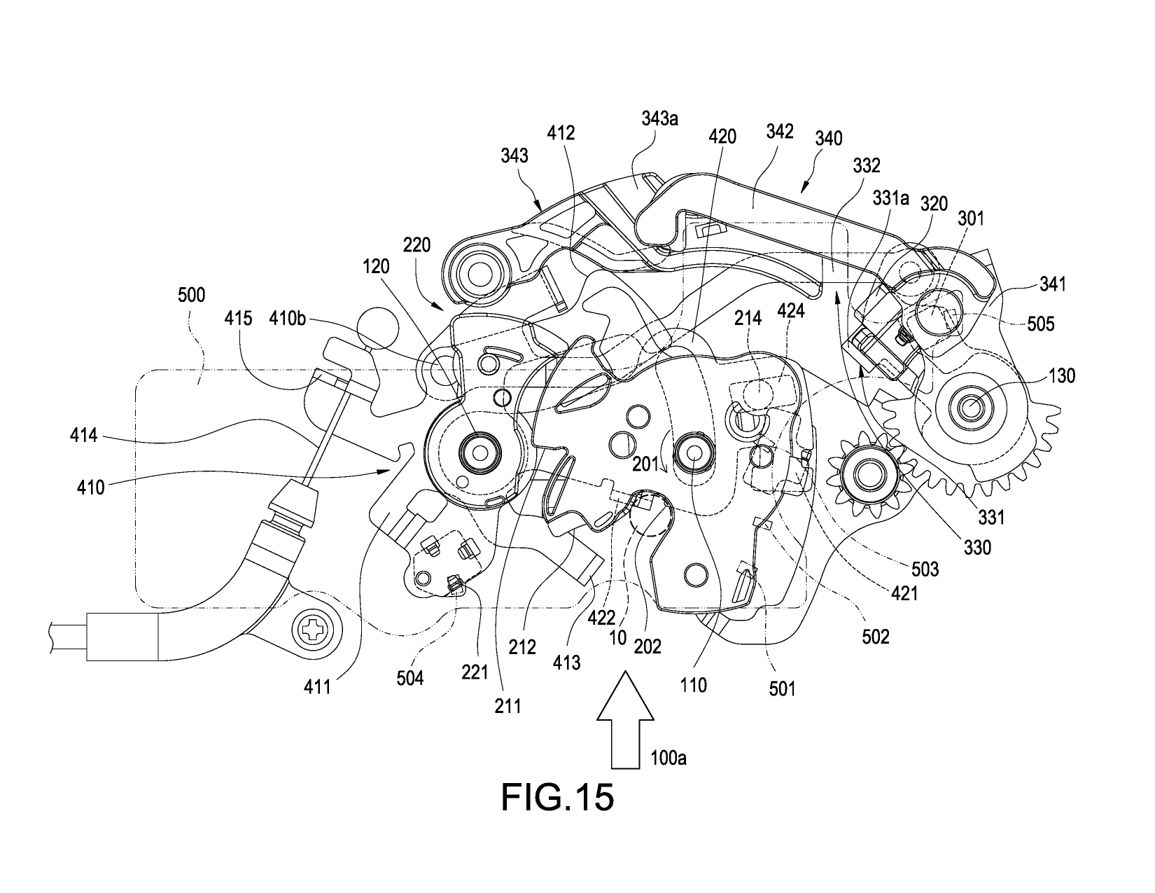

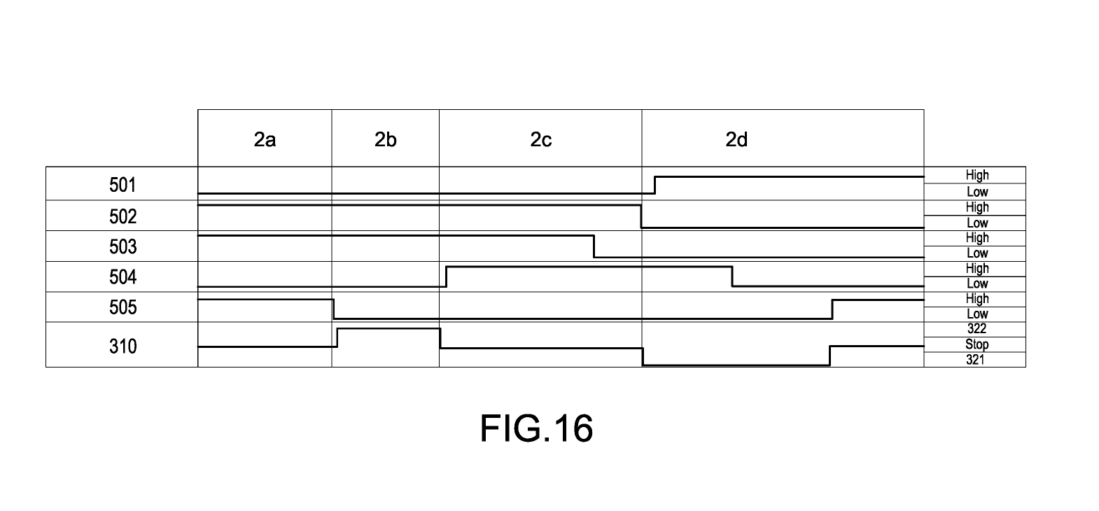

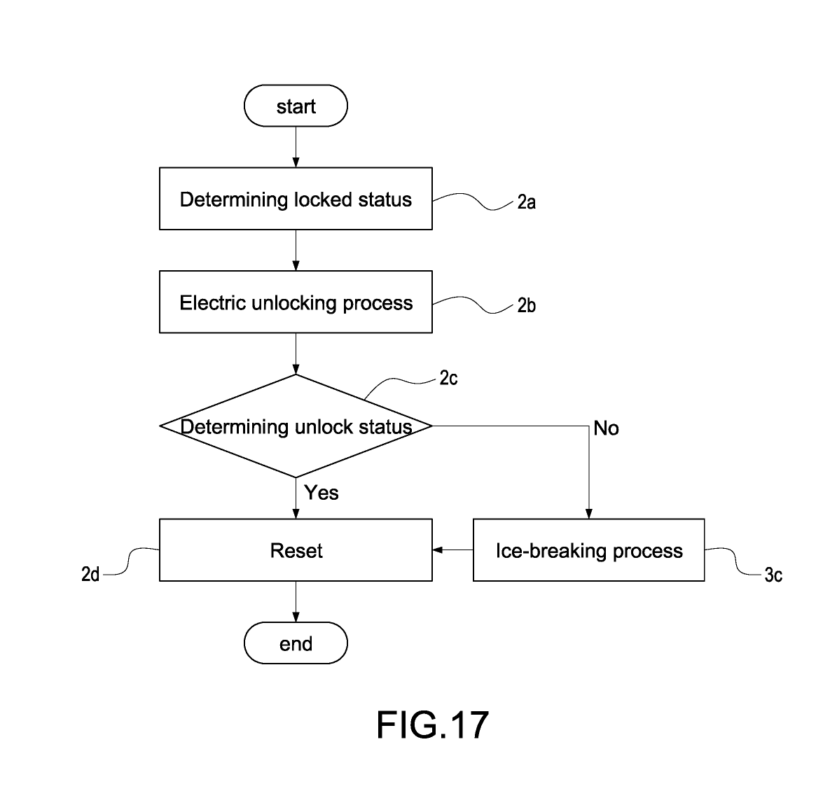

FIG. 16 is a control signal diagram of an electric unlocking process of the smart door lock mechanism according to an embodiment of this disclosure. FIG. 17 is a flow chart showing steps of the electric unlocking process of the smart door lock mechanism according to an embodiment of this disclosure.

The control board 500 performs the electric unlocking process with the following steps:

2a) Determining locked status: According to FIGS. 14, 16 and 17, the control board 500 receives a high voltage signal from the third ratchet sensor 503 corresponding to the locked position when detecting the first magnetic element 421 and meanwhile receives another high voltage signal from the pawl sensor 504, and accordingly determines that the ratchet 210 is held by the pawl 220 at the locked position. At the same time, the control circuit board 500 receives a high potential signal from the actuation sensor 505 when detecting the third magnetic element 301, and accordingly determines that the bidirectional push rod 320 is located at the central position.

2b) Electric unlocking process: According to FIGS. 14 - 17, the control board 500 reverses the motor 310 when receiving an unlocking order, so as to rotate the bidirectional push rod 320 toward the unlocking direction 322 (actuation sensor 505 is switched to low voltage signal) to actuate the unlocking lever group 330. If the control board 500 detects that the pawl sensor 504 is switched to high voltage signal and accordingly determines that the pawl 220 is retract from the holding position to release the ratchet 210, the control board 500 stop the motor 310 to maintain the pawl 220 releasing the ratchet 210 and then performs the next step.

2c) Determining an unlock status: According to FIGS. 15 - 17, if the control board 500 detects that the first ratchet sensor 501 corresponding to the unlock position is switched to high voltage signal and the pawl sensor 504 is switched to low voltage signal, the control board 500 may determine that the ratchet 210 is located the unlock position and the and the pawl 220 is reset to the holding position and the unlocking process is accomplished, and may then process the step 2d).

2d) Reset: The control board 500 may rotate the motor 310 forward to reset the unlocking lever group 330. The control board 500 may stop the motor 310 if the control board 500 detects the third magnetic element 301 and accordingly determines that the bidirectional push rod 320 is reset to the central position.

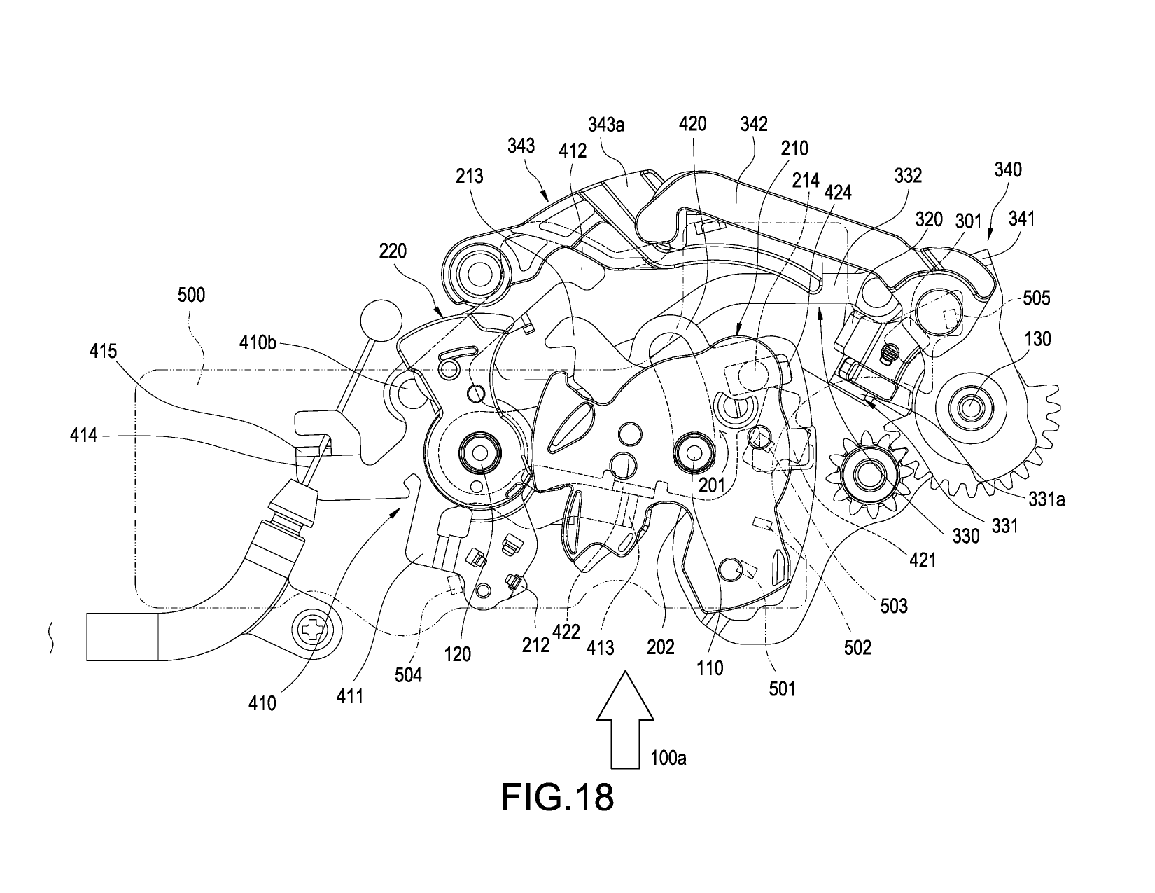

FIG. 18 is a schematic view showing an ice-breaking process of the smart lock mechanism according to one embodiment of this disclosure. According to FIG. 14, when the multifunctional lever 410 is rotated by the bilateral pushing lever 320 toward the actuating direction 401 to process the electric unlocking process or when the control board 500 detects that the ratchet 210 is released from the pawl 220 (namely manually unlocked), but the ratchet 210 is not detected at the unlock position by the control board 500, the control board 500 would determine that the ratchet 210 is stuck and then process an ice-breaking process described following, namely unlocking by an direct operation to the ratchet 210. Specifically, the multifunctional lever 410 has an ice-breaking actuating portion 413 for actuating the ice-breaking lever 420, the ice-breaking actuating portion 413 is a branch arm extended from the multifunctional lever 410, the ice-breaking lever 420 is linked with the ratchet 210 and therefore applied with a force from the first reset element 111. Accordingly, the ice-breaking actuating portion 413 has a bent end as a reinforced structure for pushing against the ice-breaking lever 420, and the ice-breaking lever 420 has a portion on a periphery thereof which is bent to form an interference wall 422 allowing the ice-breaking actuating portion 413 to push against. The pawl actuating portion 411, the rail actuating portion 412 and the ice-breaking actuating portion 413 mentioned above are disposed on the periphery of the multifunctional lever 410. When the multifunctional lever 410 is rotated toward the actuating direction 401, the pawl 220, the rail arm 343 and the ice-breaking lever 420 are respectively actuated in sequence. The control board 500 controls the bilateral pushing lever 320 to further rotate toward the unlocking direction 322 so that the multifunctional lever 410 is further rotated toward the actuating direction 401 until that the ice-breaking lever 420 is rotated by the ice-breaking actuating portion 413 about the second shaft 120, the ice-breaking lever 420 moves the linked hook 214 on the ratchet 210 via the engaging slot 424 when rotating. Accordingly, the ratchet 210 is rotated about the first shaft 110 toward the releasing direction 201 to the unlock position.

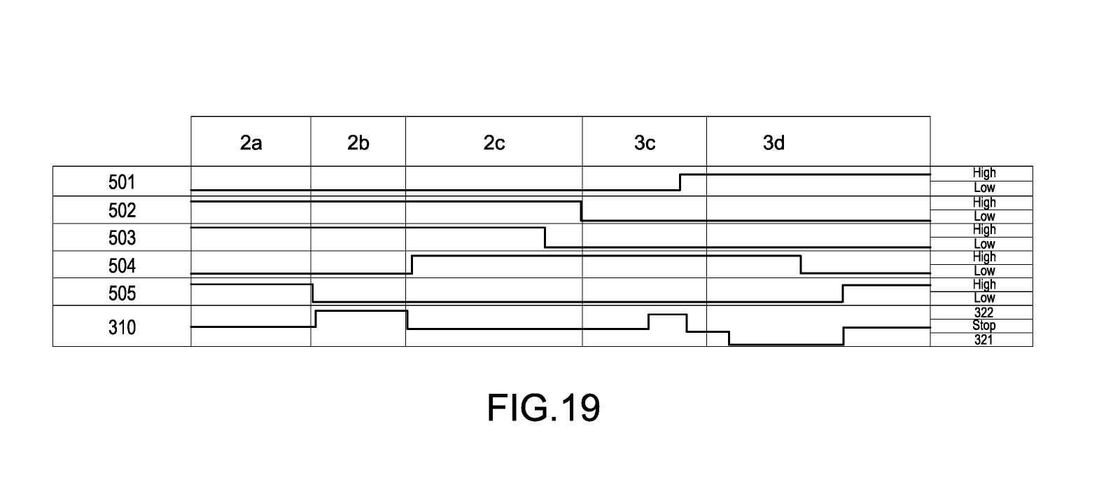

FIG. 19 is a control signal diagram of an electric ice-breaking process of the smart door lock mechanism according to an embodiment of this disclosure. The control board 500 performs the ice-breaking process with the following steps:

The steps 2a) and 2b) are firstly executed in sequence as shown in FIGS. 14, 17 and 19.

2c) Determining the unlock status: A process is performed to determine the unlock status after a predetermined time (predetermined 1 second according to this embodiment). The ratchet 210 may be determined as stuck if the control board 500 does not detects that the first ratchet sensor 501 is switched to high voltage signal (determined as stuck at the locked position if both of the second ratchet sensor 502 and the third ratchet sensor 503 generate high voltage signals ,and determined as stuck at the semi-locked position if the second ratchet sensor 502 generates a high voltage signal and the third ratchet sensor 503 generates a low voltage signal). Accordingly, the control board 500 performs an ice-breaking process in step 3c if cannot determine the unlock status).

3c) Ice-breaking process: According to FIGS. 17 - 19, the motor 310 is further rotated backward to further rotate the bidirectional push rod 320 toward the unlocking direction 322 and further actuate the unlocking lever group 330 and stop the motor 310 if detecting that the first ratchet sensor 501 is switched to high voltage signal. The control board 500 may determine that the ratchet 210 is located at the unlock position if detecting that the first ratchet sensor 501 is switched to high voltage signal, so as to determine that the ice-breaking is accomplish and perform the next step 2d).

2d) Reset: The control board 500 may rotate the motor 310 forward to reset the unlocking lever group 330. The control board 500 may stop the motor 310 if the control board 500 detects the third magnetic element 301 and accordingly determines that the bidirectional push rod 320 is reset to the central position.

The smart lock mechanism disclosed according to this disclosure performs an operation to the ratchet 210 and the lock plate pawl 220 by a bidirectional rotation of single motor 310, and the pawl 220 is further provided with a multifunctional lever 410, so that various unlocking and locking actions may be respectively performed by single motor 310.

While this disclosure has been described by means of specific embodiments, numerous modifications and variations may be made thereto by those skilled in the art without departing from the scope and spirit of this disclosure set forth in the claims.

What is claimed is:

1. A smart lock mechanism, comprising:
a structural assembly, comprising a first shaft, a second shaft and a third shaft arranged thereon;
a ratchet, pivoted on the first shaft and preset at an unlock position by a first reset element, and the ratchet rotatable to a locked position and a semi-locked position between the unlock position and the locked position;
an ice-breaking lever, pivoted on the second shaft and engaged with the ratchet so as to be rotationally linked with the ratchet, wherein a first magnetic element is arranged on the ice-breaking lever;
a pawl, pivoted on the second shaft and preset at a holding position by a second reset element to hold the ratchet at the semi-locked position or the locked position, and the pawl capable of rotating to release the ratchet, and a second magnetic element arranged on the pawl;
a driving assembly, comprising a motor, a bilateral pushing lever and an unlocking lever group and a locking lever group, the bilateral pushing lever pivoted on the third shaft, the motor be used for rotating the bilateral pushing lever from a central position toward a locking direction or an unlocking direction, a third magnetic element arranged on the bilateral pushing lever, wherein the locking lever group is actuated by the bilateral pushing lever when the bilateral pushing lever rotated along the locking direction;
a multifunctional lever, pivoted on the second shaft connected with the unlocking lever group, the multifunctional lever comprising a pawl actuating portion and an ice-breaking actuating portion, the pawl actuating portion being used for pushing the pawl to unlock the ratchet, wherein the multifunctional lever is actuated by the bilateral pushing lever the through the locking lever group when the bilateral pushing lever is rotated along the locking direction; and
a control board, provided with a first ratchet sensor, a second ratchet sensor, a third ratchet sensor, a pawl sensor and a actuation sensor, the control board capable of detecting the ratchet at the unlock position, the semi-locked position or the locked position by detecting the first magnetic element on the ice-breaking lever with the third ratchet sensor, the second ratchet sensor or the first ratchet sensor correspondingly, the control board capable of detecting the second magnetic element with the pawl sensor when the pawl is located at the holding position, the control board capable of detecting the third magnetic element with the actuation sensor when the bilateral pushing lever is located at the central position.

2. The smart lock mechanism according to claim 1, wherein the locking lever group comprises a locking actuator, the locking actuator is pivoted on the third shaft and pivoted with a claw for engaging with the ratchet, the structural assembly is provided with a rail, the claw comprises a portion inserted in the rail,
wherein when the first magnetic element is detected by the first ratchet sensor and the second ratchet sensor in sequence, the control board drives the motor to rotate the bilateral pushing lever toward the locking direction to actuator the locking actuator to perform an electric locking process by moving the claw along the rail to rotate the ratchet until the first magnetic element is detected by both of the second ratchet sensor and the third ratchet sensor.

3. The smart lock mechanism according to claim 1, wherein when the first magnetic element is detected by the first ratchet sensor and the control board receives an unlocking order, the control board drive the motor to rotate the bilateral pushing lever toward the unlocking direction and actuate the unlocking lever group to perform an electric unlocking process by rotating the multifunctional lever to push the rachet away from the ratchet by the rachet actuating portion.

4. The smart lock mechanism according to claim 3, wherein if the first magnetic element is not detected by the first ratchet sensor when the control board drives the motor to rotate the bilateral pushing lever toward the unlocking direction, the control board drives the motor to further rotate the bilateral pushing lever toward the unlocking direction to perform an ice-breaking unlocking process by further rotating the multifunctional lever to actuate the ratchet until the first magnetic element is detected by the first ratchet sensor.

5. The smart lock mechanism according to claim 1, wherein if the first magnetic element is detected by the third ratchet sensor but the first magnetic element is not detected by the second ratchet sensor when the control board is performing an electric locking process, the control board drives the motor to reverse until the third magnetic element is detected by the actuation sensor.

6. The smart lock mechanism according to claim 1, wherein if the second magnetic element is not detected by the pawl sensor when the control board is performing an electric unlock process, the control board stop driving the motor to hold the pawl.

7. The smart lock mechanism according to claim 6, wherein if the first magnetic element is detected by the first ratchet sensor when the control board is performing the electric unlock process, the control board drives the motor to reverse until the third magnetic element is detected by the actuation sensor.

8. The smart lock mechanism according to claim 1, wherein if the first magnetic element is detected by the first ratchet sense when the control board is performing a process, the control board drives the motor to reverse until the third magnetic element is detected by the actuation sensor.

9. The smart lock mechanism according to claim 2, further comprises a rail arm, the rail arm is pivoted on the structural assembly, and the rail is arranged on the rail arm, the multifunctional lever pushes the rail arm away from the ratchet.

10. The smart lock mechanism according to claim 9, wherein the ratchet escapes from a moving route of the claw when the multifunctional lever is rotated to push the rail arm away from the ratchet.

11. The smart lock mechanism according to claim 9, wherein when the locking actuator is pushed by the bilateral pushing lever to rotate the ratchet toward the locked position, the multifunctional lever is meanwhile rotated to move the claw away from the ratchet.

12. The smart lock mechanism according to claim 11, wherein the multifunctional lever is connected with a cable, the multifunctional lever can be pulled by the cable to rotate to push the pawl away from the ratchet.

13. The smart lock mechanism according to claim 1, wherein the pawl actuating portion and the ice-breaking actuating portion are branch arms extended from the multifunctional lever.

14. The smart lock mechanism according to claim 1, wherein the multifunctional lever pushes the ice-breaking lever to actuate the ratchet.

15. The smart lock mechanism according to claim 1, wherein the multifunctional lever is connected to a cable allowing the multifunctional lever to be pulled by the cable to rotate and push the pawl away from the ratchet.
